(19) United States
(12) Patent Application Publication
(10) Pub. No.: US 2025/0093468 A1
(43) Pub. Date: Mar. 20, 2025

(54) Apparatus For Controlling Vehicle And Method Thereof

(71) Applicants: Hyundai Motor Company, Seoul (KR); Kia Corporation, Seoul (KR)

(72) Inventor: Ju Hyeok Ra, Guri-Si (KR)

(21) Appl. No.: 18/635,137

(22) Filed: Apr. 15, 2024

(30) Foreign Application Priority Data
Sep. 18, 2023 (KR) 10-2023-0124148

(51) Int. Cl. G01S 7/48; G01S 17/89

(52) U.S. Cl. CPC G01S 7/4808; G01S 17/89

(57) ABSTRACT

An apparatus for controlling a vehicle is introduced. The apparatus is configured to generate and correct road boundaries based on objects detected by a sensor and map information associated with global positioning system when it is difficult to determine road boundaries due to occlusion and disappearance of boundary object(s).

### CROSS-REFERENCE TO RELATED APPLICATION

This application claims the benefit of priority to Korean Patent Application No. 10-2023-0124148, filed in the Korean Intellectual Property Office on Sep. 18, 2023, the entire contents of which are incorporated herein by reference.

### TECHNICAL FIELD

The present disclosure relates to a vehicle control apparatus and a method thereof, and more particularly, relates to a technology for using light detection and ranging (LiDAR).

### BACKGROUND

Various studies are being conducted to identify an external object by using various sensors to assist a host vehicle in driving.

In particular, while the host vehicle is driving in a driving assistance device activation mode or an autonomous driving mode, the external object may be identified by using a sensor (e.g., LiDAR).

There is a need to accurately identify a region, in which the host vehicle is capable of driving, by identifying a road edge through a sensor (e.g., LiDAR). In particular, if the road edge is occluded by an external object (e.g., an external vehicle), issues (e.g., the road edge disappears) may occur.

### SUMMARY

According to the present disclosure, an apparatus comprising a sensor, a communication circuit, and a processor, wherein the processor is configured to determine a first reference point within a line segment corresponding to a rear surface of an external vehicle, wherein the line segment is one of line segments forming a first virtual box corresponding to the external vehicle detected through the sensor, remove, based on tracking the first reference point in regions divided by grids associated with frames of a designated section, points from a plurality of points obtained through the sensor relative to at least one of a second reference point located within a second line segment corresponding to a rear surface of a first stationary object, wherein the second line segment is one of line segments forming a second virtual box corresponding to the first stationary object, or a third reference point located within a third line segment corresponding to a rear surface of a second stationary object, wherein the third line segment is one of line segments forming a third virtual box corresponding to the second stationary object wherein the points are placed in a region different from a region where a host vehicle is present, determine an error related to a location of the host vehicle by comparing a first location of the host vehicle, which is included in map information received through the communication circuit and a second location of the host vehicle, which is included in global positioning system (GPS) information, based on determining that the error is smaller than a reference error, compare a first width of a road, on which the host vehicle is driving and which is included in the map information and a second width based on a distance between the first stationary object and the second stationary object, determine at least one of the first stationary object or the second stationary object as a road edge, based on a difference between the first width and the second width being smaller than or equal to a first reference width, and output a signal indicating the road edge.

The apparatus, wherein the processor is configured to determine that at least one of the first stationary object or the second stationary object is not a road edge, based on the difference between the first width and the second width being greater than the first reference width.

The apparatus, wherein the processor is configured to generate a histogram based on a region and a coordinate of a second axis of the first reference point tracked on a plane formed by a first axis and the second axis, wherein the region is divided by the grids, the first axis corresponds to a driving direction of the host vehicle, and the second axis is perpendicular to the first axis.

The apparatus, wherein the processor is configured to generate the histogram based on the first reference point detected in the regions divided by the grids and partial regions obtained by dividing the regions at a designated interval, and wherein the regions divided by the grids include regions for dividing lanes on each of which the host vehicle is capable of driving.

The apparatus, wherein the processor is configured to determine at least one of a first coordinate of a second axis of the first reference point, a second coordinate of the second axis of the second reference point, or a third coordinate of the second axis of the third reference point, wherein the at least one of the first coordinate, the second coordinate, or the third reference point is identified on a plane formed by a first axis and the second axis perpendicular to the first axis, wherein the first axis corresponds to a driving direction of the host vehicle, and determine that the first stationary object is located to a left side of the host vehicle based on the first coordinate of the second axis exceeding the second coordinate of the second axis, determine that the first stationary object is located to a right side of the host vehicle based on the first coordinate of the second axis being smaller than the second coordinate of the second axis, determine that the second stationary object is located to a left side of the host vehicle based on the first coordinate of the second axis exceeding the third coordinate of the second axis, or determine that the second stationary object is located to a right side of the host vehicle based on the first coordinate of the second axis being smaller than the third coordinate of the second axis.

The apparatus, wherein the processor is configured to determine the first stationary object as a first road edge based on a length of the second virtual box being greater than or equal to a first reference length, virtual boxes, each of from the second virtual box, not being which is different present in a region where the second virtual box is detected, a distance between the second reference point and the host vehicle being smaller than or equal to a first reference distance, and the second virtual box including a designated type of points by a second reference number or more, or determine the second stationary object as a second road edge based on a length of the third virtual box being greater than or equal to the first reference length, virtual boxes, each of which is different from the third virtual box, not being present in a region where the third virtual box is detected, a distance between the third reference point and the host vehicle being smaller than or equal to the first reference distance, and the third virtual box including a designated type of points by the second reference number or more.

The apparatus, wherein the processor is configured to determine the first location and the second location in the grids for dividing a plane formed by a first axis and a second axis, wherein the first axis corresponds to a driving direction of the host vehicle and the second axis is perpendicular to the first axis, determine a first error in a direction of the first axis based on a first coordinate of the first axis included in the first location and a second coordinate of the first axis included in the second location, determine a second error in a direction of the second axis of the host vehicle based on a fourth coordinate of the second axis included in the first location and a fifth coordinate of the second axis included in the second location, and compare, based on the first error being smaller than a first reference error and the second error being smaller than a second reference error, the first width and the second width.

The apparatus, wherein the processor is configured to determine a region, in which the host vehicle is capable of driving, from among the regions divided by the grids, and determine that at least one of the first stationary object or the second stationary object is not a road edge, based on determining a stationary object, which is different from at least one of the first stationary object or the second stationary object in a region adjacent to a region where at least one of the first stationary object or the second stationary object is present.

The apparatus, wherein the processor is configured to determine at least one of the first stationary object or the second stationary object as a road edge based on at least one of a length of the second virtual box or a length of the third virtual box being greater than or equal to a second reference length, determine a first point, which is closest to the host vehicle, from among points included in the second virtual box, determine a second point, which is closest to the host vehicle, from among points included in the third virtual box, and determine at least one of the first stationary object or the second stationary object as a road edge, based on a difference between a distance between the first point and the second point and a road width included in the map information being smaller than or equal to a second reference width.

According to the present disclosure, a method comprising determining a first reference point within a line segment corresponding to a rear surface of an external vehicle, wherein the line segment is one of line segments forming a first virtual box corresponding to the external vehicle detected through a sensor, removing, based on tracking the first reference point in regions divided by grids associated with frames of a designated section, points from a plurality of points obtained through the sensor relative to at least one of a second reference point located within a second line segment corresponding to a rear surface of a first stationary object, wherein the second line segment is one of the line segments forming a second virtual box corresponding to the first stationary object, or a third reference point located within a third line segment corresponding to a rear surface of a second stationary object, wherein the third line segment is one of the line segments forming a third virtual box corresponding to the second stationary object, determining an error related to a location of a host vehicle by comparing a first location of the host vehicle, which is included in map information received through a communication circuit and a second location of the host vehicle, which is included in GPS information, based on determining that the error is smaller than a reference error, comparing a first width of a road, on which the host vehicle is driving and which is included in the map information and a second width based on a distance between the first stationary object and the second stationary object, determining at least one of the first stationary object or the second stationary object as a road edge, based on a difference between the first width and the second width being smaller than or equal to a first reference width, and outputting a signal indicating the road edge.

The method, further comprising determining that at least one of the first stationary object or the second stationary object is not a road edge, based on the difference between the first width and the second width being greater than the first reference width.

The method, further comprising generating a histogram based on a region and a coordinate of a second axis of the first reference point tracked on a plane formed by a first axis and the second axis, wherein the region is divided by the grids, the first axis corresponds to a driving direction of the host vehicle, and the second axis is perpendicular to the first axis.

The method, further comprising generating the histogram based on the first reference point detected in the regions divided by the grids and partial regions obtained by dividing the regions at a designated interval, and wherein the regions divided by the grids include regions for dividing lanes on each of which the host vehicle is capable of driving.

The method, further comprising determining at least one of a first coordinate of a second axis of the first reference point, a second coordinate of the second axis of the second reference point, or a third coordinate of the second axis of the third reference point, wherein the at least one of the first coordinate, the second coordinate, or the third reference point is identified on a plane formed by a first axis and the second axis perpendicular to the first axis, wherein the first axis corresponds to a driving direction of the host vehicle, and determining that the first stationary object is located to a left side of the host vehicle based on the first coordinate of the second axis exceeding the second coordinate of the second axis, determining that the first stationary object is located to a right side of the host vehicle based on the first coordinate of the second axis being smaller than the second coordinate of the second axis, determining that the second stationary object is located to a left side of the host vehicle based on the first coordinate of the second axis exceeding the third coordinate of the second axis, or determining that the second stationary object is located to a right side of the host vehicle based on the first coordinate of the second axis being smaller than the third coordinate of the second axis.

The method, further comprising determining the first stationary object as a first road edge based on a length of the second virtual box being greater than or equal to a first reference length, virtual boxes, each of which is different from the second virtual box, not being present in a region where the second virtual box is detected, a distance between the second reference point and the host vehicle being smaller than or equal to a first reference distance, and the second virtual box including a designated type of points by a second reference number or more, or determining the second stationary object as a second road edge based on a length of the third virtual box being greater than or equal to the first reference length, virtual boxes, each of which is different from the third virtual box, not being present in a region where the third virtual box is detected, a distance between the third reference point and the host vehicle being smaller than or equal to the first reference distance, and the third virtual box including a designated type of points by the second reference number or more.

The method, further comprising determining the first location and the second location in the grids for dividing a plane formed by a first axis and a second axis, wherein the first axis corresponds to a driving direction of the host vehicle and the second axis is perpendicular to the first axis, determining a first error in a direction of the first axis based on a first coordinate of the first axis included in the first location and a second coordinate of the first axis included in the second location, determining a second error in a direction of the second axis of the host vehicle based on a fourth coordinate of the second axis included in the first location and a fifth coordinate of the second axis included in the second location, and comparing, based on the first error being smaller than a first reference error and the second error being smaller than a second reference error, the first width and the second width.

The method, further comprising determining a region, in which the host vehicle is capable of driving, from among the regions divided by the grids, and determining that at least one of the first stationary object or the second stationary object is not a road edge based on determining a stationary object, which is different from at least one of the first stationary object or the second stationary object in a region adjacent to a region where at least one of the first stationary object is present.

The method, further comprising determining at least one of the first stationary object or the second stationary object as a road edge based on at least one of a length of the second virtual box or a length of the third virtual box being greater than or equal to a second reference length, determining a first point, which is closest to the host vehicle, from among points included in the second virtual box, determining a second point, which is closest to the host vehicle, from among points included in the third virtual box, and determining at least one of the first stationary object or the second stationary object as a road edge, based on a difference between a distance between the first point and the second point and a road width included in the map information being smaller than or equal to a second reference width.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control apparatus, according to an example of the present disclosure;

FIG. 2 shows an example of identifying an external object and a road edge by a vehicle control apparatus, according to an example of the present disclosure;

FIG. 3 shows an example in which a vehicle control apparatus generates a histogram by tracking an external vehicle, according to an example of the present disclosure;

FIG. 4 shows an example of outputting a road edge by a vehicle control apparatus, according to an example of the present disclosure;

FIG. 5 shows an example in which a vehicle control apparatus identifies a road edge, according to an example of the present disclosure;

FIG. 6 shows an example of a flowchart of a vehicle control method, according to an example of the present disclosure;

FIG. 7 shows an example of a flowchart of a vehicle control method, according to an example of the present disclosure; and

FIG. 8 shows an example of a computing system associated with a vehicle control apparatus, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components have the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

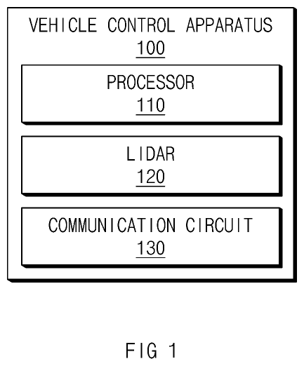

Hereinafter, various examples of the present disclosure will be described in detail with reference to FIGS. 1 to 8.

FIG. 1 shows an example of a block diagram of a vehicle control apparatus, according to an example of the present disclosure.

Referring to FIG. 1, a vehicle control apparatus 100 according to an example of the present disclosure may be implemented inside or outside a vehicle (e.g., host vehicle), and some of components included in the vehicle control apparatus 100 may be implemented inside or outside the vehicle. At this time, the vehicle control apparatus 100 may be integrated with internal control units of a vehicle and may be implemented with a separate device so as to be connected to control units of the vehicle by means of a separate connection means. For example, the vehicle control apparatus 100 may further include components not shown in FIG. 1.

Referring to FIG. 1, the vehicle control apparatus 100 according to an example may include a processor 110, a sensor (e.g., a LiDAR 120), and a communication circuit 130. The processor 110, the LiDAR 120, or the communication circuit 130 may be electrically or operably coupled with each other by an electronic component including a communication bus.

Hereinafter, the fact that pieces of hardware are coupled operably may include the fact that a direct and/or indirect connection between the pieces of hardware is established by wired and/or wirelessly such that second hardware is controlled by first hardware among the pieces of hardware. Although different blocks are shown, an example is not limited thereto.

Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have a structure of a single-core processor, or may have a structure of a multi-core processor including a dual core, a quad core, a hexa core, or an octa core.

The vehicle control apparatus 100 according to an example may include the LiDAR 120. For example, the LiDAR 120 may obtain data sets from identifying objects surrounding the vehicle control apparatus 100. For example, the LiDAR 120 may identify at least one of a location of the surrounding object, a movement direction of the surrounding object, or a speed of the surrounding object, or any combination thereof based on a pulse laser signal emitted from the LiDAR 120 being reflected by the surrounding object and returned.

For example, the LiDAR 120 may obtain data sets including a plurality of points in the space defined by a first axis (e.g., an x-axis), a second axis (e.g., a y-axis), and a third axis (e.g., a z-axis) based on a pulse laser signal reflected from surrounding objects, For example, the LiDAR 120 may obtain data sets including a plurality of points in the space, which is formed by the first axis, the second axis, and the third axis, based on receiving the pulse laser signal at a designated period.

Hereinafter, the first axis may include the x-axis; the second axis may include the y-axis; and, the third axis may include the z-axis. However, the first axis, the second axis, and the third axis respectively referred to as the “x-axis”, the “y-axis”, and the “z-axis” are not limited to the above descriptions.

The processor 110 included in the vehicle control apparatus 100 according to an example may emit light from a host vehicle by using the LiDAR 120. For example, the processor 110 may receive light emitted from the host vehicle. For example, the processor 110 may identify at least one of a location, a speed, or a moving direction, or any combination thereof of a surrounding object based on a time required to transmit light emitted from the host vehicle and a time required to receive light emitted from the host vehicle.

For example, the processor 110 may obtain data sets including a plurality of points based on the time required to transmit light emitted from the host vehicle and the time required to receive light emitted from the host vehicle. The processor 110 may obtain data sets for expressing a plurality of points in a three-dimensional virtual coordinate system including the first axis, the second axis, and the third axis.

The communication circuit 130 included in the vehicle control apparatus 100 according to an example may include a hardware component for supporting transmission and/or reception of signals between the vehicle control apparatus 100 and an external electronic device (or an external vehicle). For example, the communication circuit 130 may include at least one of a MODEM, an antenna, or an optical/electronic (O/E) converter, or any combination thereof.

For example, the communication circuit 130 may support transmission and/or reception of signals based on various types of protocols including at least one of Ethernet, local area network (LAN), wide area network (WAN), wireless fidelity (WiFi), Bluetooth, Bluetooth low energy (BLE), ZigBee, long term evolution (LTE), 5G new radio (NR), controller area network (CAN), or local interconnect network (LIN), or any combination thereof.

The processor 110 included in the vehicle control apparatus 100 according to an example may obtain a first virtual box corresponding to an external vehicle identified through the LiDAR 120. The processor 110 may identify a first reference point within a line segment corresponding to a rear surface of the external vehicle among line segments forming the first virtual box based on obtaining a first virtual box corresponding to the external vehicle identified through the LiDAR 120.

The number of first virtual boxes is not limited to one. For example, the processor 110 included in the vehicle control apparatus 100 may identify virtual boxes corresponding to external vehicles. The processor 110 may identify reference points respectively included in the virtual boxes corresponding to the external vehicles. Hereinafter, for convenience of description, descriptions related to the first virtual box corresponding to an external vehicle will be given later.

In an example, the processor 110 may track a first reference point during frames of a designated section in regions divided by grids. For example, the processor 110 may track the first reference point in the regions divided by grids during the designated number of frames (e.g., about 10 frames).

For example, the processor 110 may identify partial regions obtained by dividing the regions, which are divided by grids, at a designated interval.

For example, the regions divided by grids may be referred to as a “lane grid”. For example, the partial regions may be referred to as “roadbim (RB) grids”.

In an example, the processor 110 may identify the first reference point in regions indicating a road, and the partial regions obtained by dividing the regions indicating the road at a designated interval. The processor 110 may track the first reference point in the regions indicating a road, and the partial regions obtained by dividing the regions for representing the road at a designated interval.

The processor 110 may generate a histogram based on the first reference point in regions indicating a road and partial regions obtained by dividing the regions indicating the road at a designated interval.

In an example, the processor 110 may track the first reference point on a plane formed by the first axis and the second axis among the first axis, the second axis, and the third axis. The processor 110 may identify the coordinates of the first reference point tracked on a plane formed by the first axis and the second axis among the first axis, the second axis, and the third axis.

The processor 110 may generate a histogram based on tracking the first reference point during the frames of a designated section in the regions divided by grids. For example, the first reference point may be referred to as a “tracking point for tracking an external vehicle”.

In an example, the processor 110 may identify a second reference point located within a line segment, which corresponds to a rear surface of a first stationary object, from among line segments forming a second virtual box corresponding to the first stationary object. The processor 110 may identify a third reference point located within a line segment, which corresponds to a rear surface of a second stationary object, from among line segments forming a third virtual box corresponding to the second stationary object. For example, the second reference point may be referred to as a “tracking point for tracking the first stationary object”. For example, the third reference point may be referred to as a “tracking point for tracking the second stationary object”.

For example, the rear surface of the first stationary object and/or the rear surface of the second stationary object may include a direction opposite to a direction in which the host vehicle is driving. For example, if the direction in which the host vehicle is driving is a positive direction of the first axis among the first axis, the second axis, and the third axis, the rear surface of the first stationary object and/or the rear surface of the second stationary object may include a surface (or a line segment) corresponding to a point identified by the smallest coordinate among coordinates of a direction of the first axis.

In an example, the processor 110 may identify at least one of a region where the host vehicle is capable of driving, or a region different from the region where the host vehicle is capable of driving, or any combination thereof based on the second reference point located within a line segment corresponding to the rear surface of the first stationary object among line segments forming the second virtual box corresponding to the first stationary object, and/or the third reference point located within a line segment corresponding to the rear surface of the second stationary object among line segments forming the third virtual box corresponding to the second stationary object.

For example, the processor 110 may identify a region between the second reference point and the third reference point as a region where the host vehicle is capable of driving. For example, the processor 110 may identify a region different from the region between the second reference point and the third reference point as a region different from the region where the host vehicle is capable of driving. For example, the region different from the region where the host vehicle is capable of driving may include a region outside a road edge.

In an example, on the basis of tracking the first reference point in regions divided by grids during frames of a designated section, the processor 110 may remove points placed in a region, which is different from the region where the host vehicle is capable of driving, among points obtained through the LiDAR 120 relative to at least one of the second reference point located within the line segment corresponding to the rear surface of the first stationary object among line segments forming the second virtual box corresponding to the first stationary object, or the third reference point located within the line segment corresponding to the rear surface of the second stationary object among line segments forming the third virtual box corresponding to the second stationary object, or any combination thereof.

For example, the processor 110 may initialize a histogram by using points placed in a region different from the region in which the host vehicle is capable of driving.

In an example, the processor 110 may receive map information including a first location of the host vehicle through the communication circuit 130. For example, the map information may include precise map information. For example, the processor 110 may receive the precise map information including the first location of the host vehicle through the communication circuit 130.

For example, the precise map information may include at least one of first information for determining whether the host vehicle has entered a precise map section, second information related to a longitudinal positioning accuracy of the host vehicle, third information related to a lateral positioning accuracy of the host vehicle, or fourth information related to a location of the host vehicle and the number of lanes on which the host vehicle is driving, or any combination thereof.

For example, the longitudinal positioning accuracy of the host vehicle may include location accuracy in a first axis direction on a plane formed by the first axis and the second axis. For example, the lateral positioning accuracy of the host vehicle may include location accuracy in a second axis direction on a plane formed by the first axis and the second axis. For example, the fourth information related to the location of the host vehicle and the number of lanes on which the host vehicle is driving may include information related to the location of the host vehicle and a lane on which the host vehicle is driving, based on the rear wheel axis of the host vehicle.

For example, the processor 110 may identify at least one of the longitudinal positioning accuracy of the host vehicle, or the lateral positioning accuracy of the host vehicle, or any combination thereof based on the precise map information. For example, at least one of the longitudinal positioning accuracy of the host vehicle, or the lateral positioning accuracy of the host vehicle, or any combination thereof may be related to an error between the location of the host vehicle included in global positioning system (GPS) information and a location of the host vehicle included in the precise map information.

In an example, the processor 110 may obtain the GPS information. For example, the processor 110 may receive the GPS information from an external electronic device (e.g., a server) through the communication circuit 130 or may obtain the GPS information from a vehicle control system (or a computing system) related to the vehicle control apparatus 100.

In an example, the processor 110 may compare the first location of the host vehicle with a second location of the host vehicle included in the GPS information based on receiving the precise map information including the first location of the host vehicle through the communication circuit 130. The processor 110 may identify an error related to a location of the host vehicle based on the second location.

For example, in a two-dimensional virtual coordinate system consisting of a first axis and a second axis, the processor 110 may identify an error related to the location of the host vehicle based on the second location included in the GPS information.

In an example, the processor 110 may determine whether the error related to the location of the host vehicle is smaller in magnitude/value than a reference error based on the second location. On the basis of the fact that the error related to the location of the host vehicle is identified as being smaller than the reference error based on the second location, the processor 110 may compare a first width of a road, on which the host vehicle is driving and which is included in the precision map, with a second width based on a distance between a first stationary object and a second stationary object. For example, the distance between the first stationary object and the second stationary object may include a distance between the second virtual box and the third virtual box.

In an example, the processor 110 may identify a difference between the first width and the second width. The processor 110 may identify at least one of the first stationary object, or the second stationary object, or any combination thereof as a road edge, based on the difference between the first width and the second width being smaller than or equal to a first reference width. The processor 110 may output the identified road edge based on identifying that at least one of the first stationary object, or the second stationary object, or any combination thereof is the road edge.

For example, the processor 110 may assign an identifier (e.g., RoadEdge) indicating a road edge to a stationary object, which is identified as a road edge, from among the first stationary object and the second stationary object based on identifying that at least one of the first stationary object, or the second stationary object, or any combination thereof is the road edge.

In an example, the processor 110 may not identify at least one of the first stationary object, or the second stationary object, or any combination thereof as a road edge, based on the difference between the first width and the second width exceeding the first reference width.

In an example, the processor 110 may identify at least one of a location of the first reference point, a location of the second reference point, or a location of the third reference point, or any combination thereof, which is identified on a plane formed by the first axis and the second axis among the first axis, the second axis, and the third axis.

The processor 110 may identify a direction in which at least one of the first stationary object, or the second stationary object, or any combination thereof is located relative to the host vehicle based on at least one of the location of the first reference point, the location of the second reference point, or the location of the third reference point, or any combination thereof, which is identified on the plane formed by the first axis and the second axis among the first axis, the second axis, and the third axis.

For example, the processor 110 may identify at least one of a first coordinate of a second axis of the first reference point, a second coordinate of a second axis of the second reference point, or a third coordinate of a second axis of the third reference point, or any combination thereof.

The processor 110 may compare at least one of the first coordinate of the second axis, the second coordinate of the second axis, or the third coordinate of the second axis, or any combination thereof.

For example, the processor 110 may compare the first coordinate of the second axis with the second coordinate of the second axis. The processor 110 may identify that the first stationary object is further located to the left than the host vehicle, based on the first coordinate of the second axis being greater than the second coordinate of the second axis.

For example, the processor 110 may identify that the first stationary object is further located to the right than the host vehicle, based on the first coordinate of the second axis being smaller than the second coordinate of the second axis.

For example, the processor 110 may compare the first coordinate of the second axis with the second coordinate of the second axis. The processor 110 may identify that the second stationary object is further located to the left than the host vehicle, based on the first coordinate of the second axis being greater than the third coordinate of the second axis.

For example, the processor 110 may identify that the second stationary object is further located to the right than the host vehicle, based on the first coordinate of the second axis being smaller than the third coordinate of the second axis.

In an example, the processor 110 may identify the first location included in the precise map information and the second location included in the GPS information in grids for dividing a plane formed by the first axis and the second axis among the first axis, the second axis, and the third axis.

The processor 110 may identify a first coordinate of the first axis included in the first location. The processor 110 may identify a second coordinate of the first axis included in the second location. The processor 110 may identify a first error of a first axis direction of the host vehicle based on the first coordinate of the first axis and the second coordinate of the first axis.

The processor 110 may identify a fourth coordinate of the second axis included in the first location. The processor 110 may identify a fifth coordinate of the second axis included in the second location. The processor 110 may identify a second error of a second axis direction of the host vehicle based on the fourth coordinate of the second axis and the fifth coordinate of the second axis.

In an example, the processor 110 may determine whether the first error is smaller than a first reference error (e.g., about 5 m). The processor 110 may determine whether the second error is smaller than a second reference error (e.g., about 2 m).

The processor 110 may compare a first width with a second width based on the first error being smaller than the first reference error, and the second error being smaller than the second reference error. The processor 110 may identify at least one of the first stationary object, or the second stationary object, or any combination thereof as a road edge, based on a difference between the first width and the second width being smaller than or equal to a first reference width.

In an example, the processor 110 may identify a region, in which the host vehicle is capable of driving, from among regions divided by grids. In an example, the processor 110 may identify a region adjacent to the region, in which the host vehicle is capable of driving, from among regions divided by grids.

The processor 110 may identify at least one of the first stationary object, or the second stationary object, or any combination thereof in a region adjacent to the region where the host vehicle is capable of driving. The processor 110 may identify at least one of the first stationary object, or the second stationary object, or any combination thereof as a road edge based on identifying at least one of the first stationary object, or the second stationary object, or any combination thereof in a region adjacent to the region where the host vehicle is capable of driving.

In an example, the processor 110 may not identify at least one of the first stationary object, or the second stationary object, or any combination thereof as a road edge based on identifying a stationary object, which is different from at least one of the first stationary object, or the second stationary object, or any combination thereof, in a region adjacent to a region where at least one of the first stationary object, or the second stationary object, or any combination thereof is present.

In an example, the processor 110 may identify a length of the second virtual box corresponding to the first stationary object. The processor 110 may identify a length of the third virtual box corresponding to the second stationary object.

In an example, the processor 110 may identify at least one of the first stationary object, or the second stationary object, or any combination thereof as a road edge based on at least one of the length of the second virtual box, or the length of the third virtual box, or any combination thereof being greater than or equal to a second reference length.

In an example, the processor 110 may identify a first point, which is closest to the host vehicle, from among points included in the second virtual box. The processor 110 may identify a second point, which is closest to the host vehicle, from among points included in the third virtual box.

In an example, the processor 110 may identify a distance between the first point and the second point. The processor 110 may identify a difference between road widths included in the precise map information. The processor 110 may determine whether the difference between a road width included in the precise map information and the distance between the first point and the second point is smaller than or equal to the second reference width (e.g., about 3.5 m).

The processor 110 may identify at least one of the first stationary object, or the second stationary object, or any combination thereof as a road edge, based on the fact that the difference between the distance between the first point and the second point and the road width included in the precise map information is smaller than or equal to the second reference width. For example, at least one of the above-mentioned first point, or the above-mentioned second point, or any combination thereof may include a vertex included in at least one of the second virtual box, or the third virtual box, or any combination thereof.

As described above, the processor 110 of the vehicle control apparatus 100 according to an example may identify at least one of the first stationary object, or the second stationary object, or any combination thereof as a road edge based on the first reference point. Even if occlusion occurs or a boundary object is lost, the processor 110 may accurately identify a road edge by identifying at least one of the first stationary object, or the second stationary object, or any combination thereof as a road edge based on the first reference point.

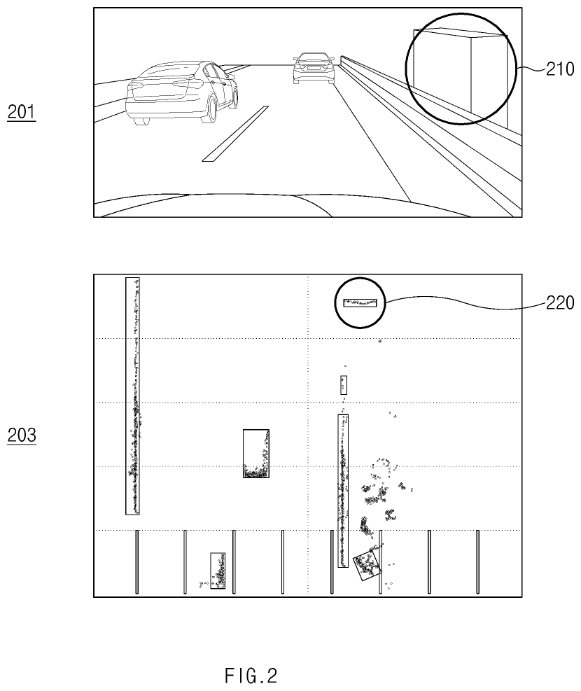

FIG. 2 shows an example of identifying an external object and a road edge (e.g., a strip of grass, a concrete or stone curb, an emergency or a bike lane, a drainage ditch, reflective markers or delineators, guard rails, trees, shrubs, or painted lines, etc.) by a vehicle control apparatus, according to an example of the present disclosure.

Referring to FIG. 2, a processor included in the vehicle control apparatus according to an example may identify a surrounding environment of a host vehicle including a first example 201. For example, the processor may identify the surrounding environment of a host vehicle based on at least one of a camera, or a sensor (e.g., LiDAR), or any combination thereof. While identifying the surrounding environment of the host vehicle, the processor may identify an external object 210 placed outside a road edge. The external object 210 needs to be identified as a stationary object placed outside the road edge.

A second example 203 may include an example of generating boxes based on points obtained by a LiDAR included in a vehicle control apparatus according to an example.

For example, in the second example 203, a virtual box 220 may correspond to the external object 210 in a first example 201. The processor needs to identify the virtual box 220 as a stationary object placed outside the road edge. However, if the stationary object is close to the road edge (e.g., within a threshold distance), the virtual box 220 may be identified as an object inside the road edge. Moreover, the virtual box 220 may be identified as a moving object that enters the inside of the road edge from the outside of the road edge, not the stationary object placed outside the road edge. For example, the outside of the road edge may be referred to as a “region where the host vehicle is incapable of driving” (e.g., a drainage ditch, unpaved road such as gravel or dirt roads, raised pavement markers, trees, shrubs, guard rails, etc.). For example, the inside of the road edge may be referred to as a “region where the host vehicle is capable of driving”.

If it is identified that the virtual box 220 enters the inside of the road edge from the outside of the road edge, an error of a vehicle control system related to the vehicle control apparatus may occur. For example, because the virtual box 220 enters the inside of the road edge from the outside of the road edge, the vehicle control system related to the vehicle control apparatus may perform an operation of adjusting the speed of the host vehicle or changing a driving route of the host vehicle. Because the driving of the host vehicle is unstable, the vehicle control system related to the vehicle control apparatus performs an operation of adjusting the speed of the host vehicle or changing the driving route of the host vehicle. Accordingly, there is a need for a solution to the unstable driving of the host vehicle.

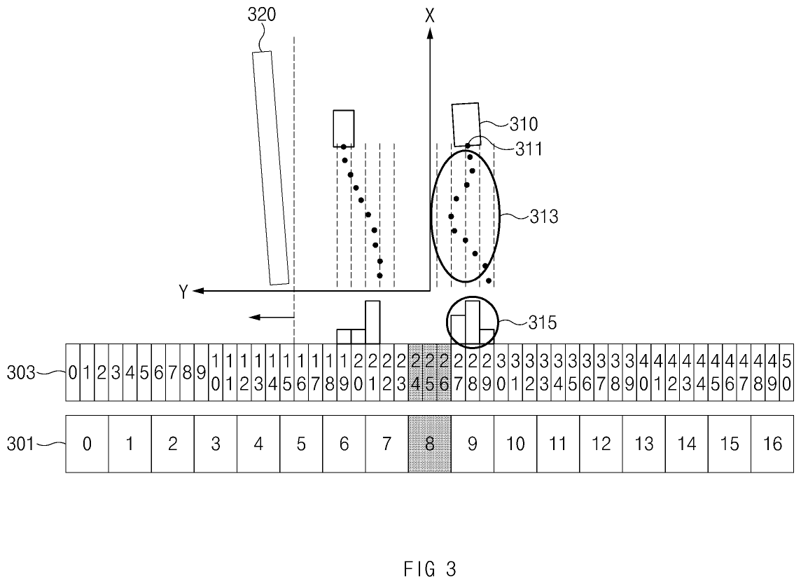

FIG. 3 shows an example in which a vehicle control apparatus generates a histogram by tracking an external vehicle, according to an example of the present disclosure.

Referring to FIG. 3, a processor included in a vehicle control apparatus according to an example may identify a first virtual box 310 corresponding to an external vehicle. The processor may identify a first reference point 311 of a first virtual box 310 corresponding to an external vehicle. For example, the processor may identify the first reference point 311 within a line segment corresponding to a rear surface of the external vehicle among line segments forming the first virtual box 310.

The processor may track the first reference point 311. For example, the processor may track the first reference point 311 during the frames of the designated section. For example, the frames of the designated section may include approximately 10 frames.

In an example, the processor may generate a histogram 315 based on points 313 tracked during the frames of the designated section.

For example, the processor may generate the histogram 315 based on grids 301 for dividing a lane, and partial grids 303 obtained by dividing the grids 301 at a designated interval.

In an example, the processor may identify a virtual box 320 corresponding to a road edge (e.g., a strip of grass, a concrete or stone curb, an emergency or a bike lane, a drainage ditch, reflective markers or delineators, guard rails, trees, shrubs, or painted lines, etc.), based on generating the histogram 315. For example, a designated identifier may be assigned to the virtual box 320 corresponding to a road edge. For example, t the designated identifier may include an identifier indicating that the virtual box 320 is a road edge.

In an example, the processor may remove points placed outside a region where the virtual box 320 corresponding to the road edge is identified or detected. For example, the outside of a region in which the virtual box 320 is identified or detected may include a region in which the first reference point 311 of the virtual box 310 corresponding to the external vehicle is not identified or detected.

In an example, the processor may identify the virtual box 320 as a stationary object (e.g., a concrete or stone curb, guard rails, trees, shrubs, a road sign post, etc.) based on the generated histogram 315 and then may determine that the identified stationary object is a road edge. The operation of determining the virtual box 320 as a road edge will be described later.

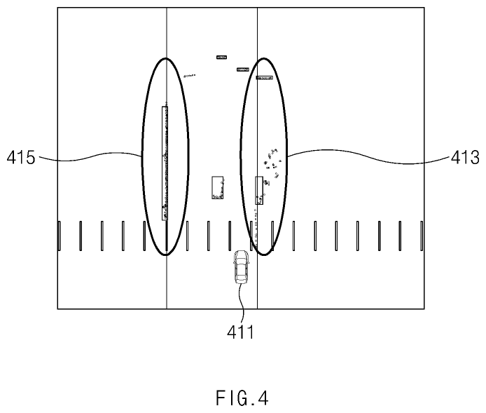

FIG. 4 shows an example of outputting a road edge by a vehicle control apparatus, according to an example of the present disclosure.

Referring to FIG. 4, a processor included in a vehicle control apparatus according to an example may identify road edges 413 and 415.

For example, when failing to identify a road edge based on the histogram 315 obtained in FIG. 3, the processor may generate road edge candidates based on virtual boxes corresponding to external objects.

In an example, while a host vehicle 411 is driving, the processor may identify the virtual boxes corresponding to the external objects. While the host vehicle 411 is driving, the processor may identify a road edge based on the external objects.

For example, the processor may identify a plurality of virtual boxes in the first region 413.

In an example, the processor may identify a length occupied by the plurality of virtual boxes, based on identifying the plurality of virtual boxes. For example, the length occupied by the plurality of virtual boxes may be identified based on a direction of a first axis among the first axis, a second axis, and a third axis. For example, the first axis may be referred to as an x-axis; the second axis may be referred to as a y-axis; and, the third axis may be referred to as z-axis. However, an example is not limited thereto.

For example, the length occupied by the plurality of virtual boxes may include a length from a minimum coordinate of the first axis to a maximum coordinate of the first axis.

For example, the processor may identify a road edge corresponding to the plurality of virtual boxes based on the length occupied by the plurality of virtual boxes being greater than or equal to a reference length (e.g., about 10-20 m), and the number of points, which have a designated type, from among points included in the plurality of virtual boxes being greater than or equal to a reference number (e.g., about 10-20). For example, the designated type of the points of may be referred to as “free-space points”. For example, the free-space points may be identified based on receiving light emitted from a LiDAR at a designated interval.

In an example, the processor may identify a virtual box in the second region 415. For example, the processor may identify a single virtual box as a road edge by using a histogram based on identifying the single virtual box. For example, the histogram may be generated based on points tracking a moving object including an external vehicle.

As described above, the processor of the vehicle control apparatus according to an example may identify a virtual box as a road edge by using a histogram. The processor may identify the virtual box as the road edge by using the histogram, thereby reducing an error in the vehicle control system related to the vehicle control apparatus.

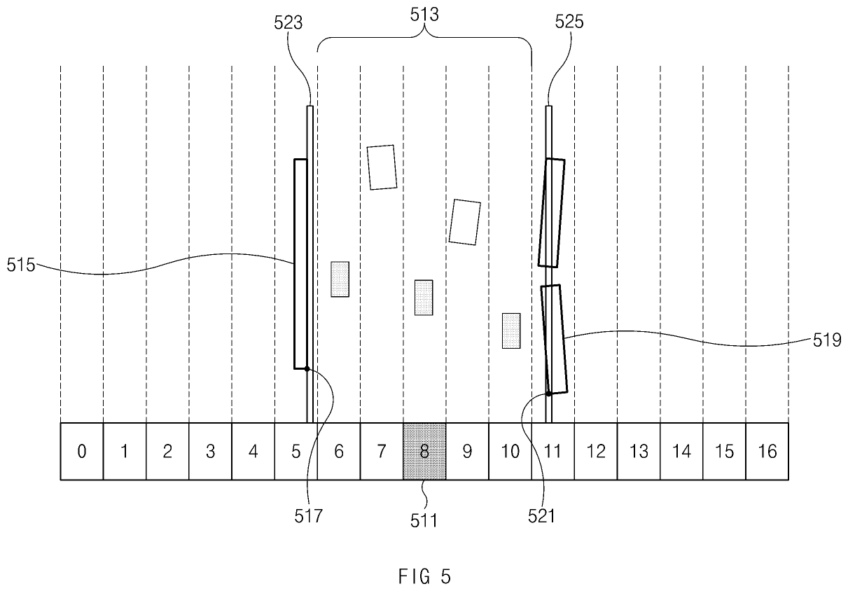

FIG. 5 shows an example in which a vehicle control apparatus identifies a road edge, according to an example of the present disclosure.

Referring to FIG. 5, a processor included in a vehicle control apparatus according to an example may identify regions divided by a plurality of grids. For example, the processor may identify a grid 511 corresponding to a lane on which the host vehicle is driving, based on regions divided by a plurality of grids.

For example, the processor may identify a region 513 (e.g., a paved road), in which the host vehicle is capable of driving, based on reference points for tracking an external vehicle. The processor may identify virtual boxes 515 and 519 in a region different from the region 513 where the host vehicle is capable of driving. For example, the virtual boxes 515 and 519 may include the virtual boxes 515 and 519 to be respectively output as road edges.

For example, the processor may perform verification to determine whether the virtual boxes 515 and 519 respectively correspond to road edges. For example, the processor may identify that regions, in which the virtual boxes 515 and 519 are identified, from among regions divided by a plurality of grids are road edges 523 and 525.

The processor may verify the road edges 523 and 525. For example, the processor may determine whether a stationary object (e.g., a post mail box, a road sign post, etc.) is placed in regions adjacent to regions identified as the road edges 523 and 525.

For example, the processor may determine whether a stationary object placed in a region adjacent to grids (e.g., grid 5 and grid 11), which are identified as the road edges 523 and 525, from among the plurality of grids. For example, the processor may determine whether the stationary object is placed in the region 513 where the host vehicle is capable of driving between the road edges 523 and 525.

For example, in FIG. 5, the processor may determine whether a stationary object is placed in grid 6 adjacent to grid 5 determined as a road edge. For example, the processor may determine whether the stationary object is present in grid 10 adjacent to grid 11 determined as a road edge. For example, each of grid 6 and grid 11 described above may be referred to as a grid adjacent to a grid identified as a road edge within a region where the host vehicle is capable of driving.

In an example, the processor may identify a size of each of the virtual boxes 515 and 519. For example, the processor may identify at least one of a width, or a length, or any combination of each of the virtual boxes 515 and 519. The processor may determine whether to output the virtual boxes 515 and 519 as road edges, based on identifying at least one of the width, or the length, or any combination of each of the virtual boxes 515 and 519.

For example, the processor may identify that the virtual boxes 515 and 519 are road edges, based on the length of each of the virtual boxes 515 and 519 exceeding a reference length (e.g., approximately 10-20 m) and then may output the identified road edges. For example, the length of each of the virtual boxes 515 and 519 may include the length of the first axis direction.

In an example, the processor may include reference points included in the virtual boxes 515 and 519, respectively. For example, the processor may identify the vertices 517 and 521, which are closest to the host vehicle, from among vertices forming the virtual boxes 515 and 519. The processor may identify each of the virtual boxes 515 and 519 as a road edge based on the fact that the length of each of the vertices 517 and 521 tracked during the frames of the designated section is smaller than a reference length (e.g., about 10-20 m) and then may output the identified road edge.

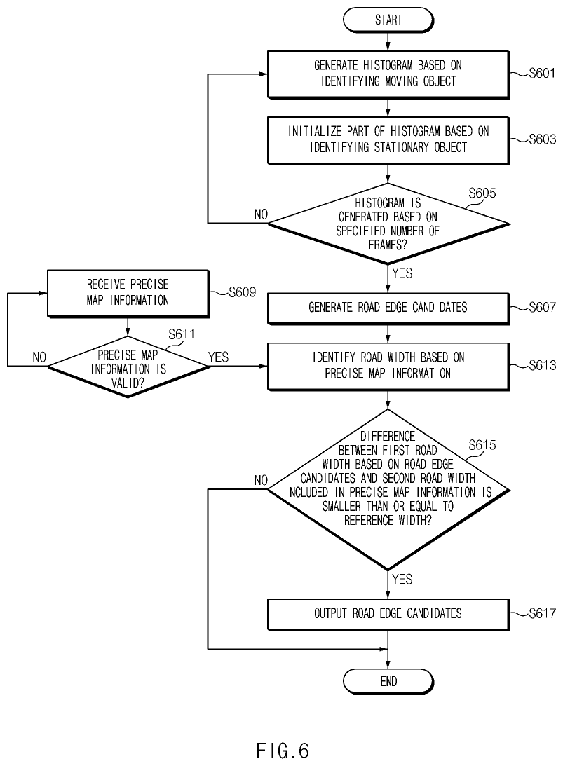

FIG. 6 shows an example of a flowchart of a vehicle control method, according to an example of the present disclosure.

Hereinafter, it is assumed that the vehicle controlling apparatus 100 of FIG. 1 performs the process of FIG. 6. In addition or alternative, in a description of FIG. 6, it may be understood that an operation described as being performed by an apparatus is controlled by the processor 110 of the vehicle control apparatus 100.

At least one of operations of FIG. 6 may be performed by the vehicle control apparatus 100 of FIG. 1. Each of the operations in FIG. 6 may be performed sequentially, but is not necessarily sequentially performed. For example, the order of operations may be changed, and at least two operations may be performed in parallel.

Referring to FIG. 6, in operation S601, a vehicle control method according to an example may include an operation of generating a histogram based on identifying a moving object. For example, the vehicle control method may include an operation of generating the histogram based on identifying the moving object corresponding to an external vehicle.

For example, the vehicle control method may include an operation of identifying a reference point of a virtual box corresponding to the moving object. The vehicle control method may include an operation of tracking a reference point during frames of a designated section based on identifying the reference point of the virtual box corresponding to the moving object. The vehicle control method may include an operation of generating the histogram based on tracking the reference point during the frames of the designated section.

In operation S603, the vehicle control method according to an example may include an operation of identifying a stationary object. The vehicle control method may include an operation of initializing a part of the histogram based on identifying the stationary object. For example, the vehicle control method may include an operation of initializing a histogram in a region different from a region where the reference point is identified. For example, the vehicle control method may include an operation of initializing the histogram of a region, in which the stationary object is identified, and a region different from a region where a reference point included in the moving object is identified.

For example, the operation of initializing the histogram may include an operation of removing a value of the histogram.

In operation S605, the vehicle control method according to an example may include an operation of determining whether a histogram is generated based on the designated number of frames. For example, the designated number of frames may include approximately 10 frames.

If the histogram is not generated based on the designated number of frames (No in operation S605), the vehicle control method according to an example may include an operation of generating a histogram by additionally or alternatively identifying or detecting a moving object.

If the histogram is generated based on the designated number of frames (Yes in operation S605), in operation S607, the vehicle control method according to an example may include an operation of generating road edge candidates.

For example, the vehicle control method may include an operation of selecting the identified stationary object as a candidate included in the road edge candidates.

In operation S609, the vehicle control method according to an example may include an operation of receiving precise map information. For example, the vehicle control method may include an operation of receiving the precise map information through a communication circuit. For example, the precise map information may include at least one of first information related to whether a host vehicle has entered a section using the precise map information, second information related to a longitudinal positioning accuracy of the host vehicle, third information related to a lateral positioning accuracy of the host vehicle, or fourth information related to a lane in which the host vehicle is driving, or any combination thereof.

In operation S611, the vehicle control method according to an example may include an operation of identifying whether the precise map information is valid.

If the precise map information is invalid (No in operation S611), the vehicle control method according to an example may include an operation of receiving the precise map information again.

If the precise map information is valid (Yes in operation S611), in operation S613, the vehicle control method according to an example may include an operation of identifying a road width based on the precise map information. For example, the vehicle control method may include an operation of identifying the road width based on the road information included in the precise map information. For example, the vehicle control method may include an operation of identifying the road width corresponding to a width between road edges.

In operation S615, the vehicle control method according to an example may include an operation of determining whether a difference between a first road width based on the road edge candidates and a second road width included in the precise map information is smaller than or equal to a reference width (e.g., about 3.5 m).

The vehicle control method according to an example may include an operation of identifying the first road width based on a distance between a first candidate located on the left side of the host vehicle and a second candidate located on the right side of the host vehicle among candidates included in road edge candidates.

The vehicle control method according to an example may include an operation of identifying whether a difference between the first road width based on the road edge candidates and the second road width included in the precise map information is smaller than or equal to the reference width.

For example, the reference width may include a width corresponding to one lane.

If the difference between the first road width based on the road edge candidates and the second road width included in the precise map information is smaller than or equal to the reference width (Yes in operation S615), in operation S617, the vehicle control method according to an example may include an operation of outputting the road edge candidates. For example, the vehicle control method may include an operation of outputting a candidate included in the road edge candidates.

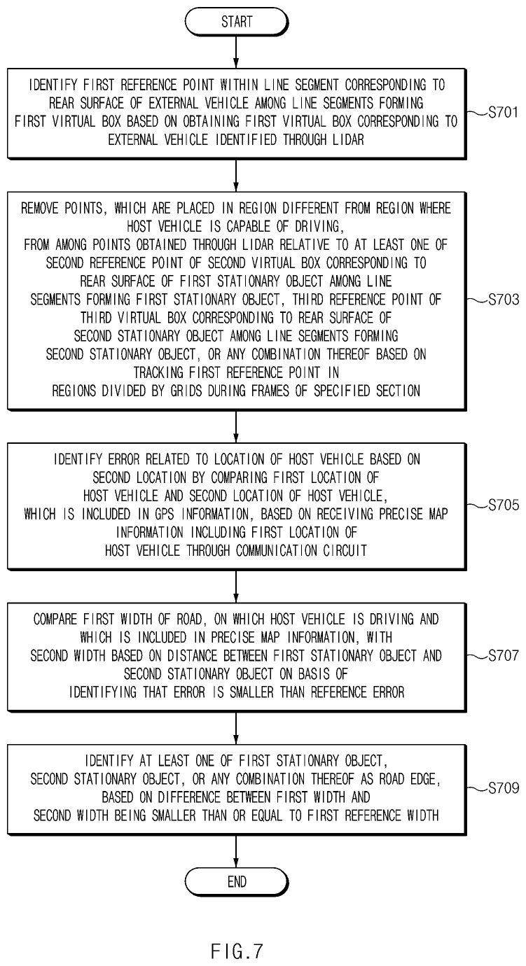

FIG. 7 shows an example of a flowchart of a vehicle control method, according to an example of the present disclosure.

Hereinafter, it is assumed that the vehicle controlling apparatus 100 of FIG. 1 performs the process of FIG. 7. In addition or alternative, in a description of FIG. 7, it may be understood that an operation described as being performed by an apparatus is controlled by the processor 110 of the vehicle control apparatus 100.

At least one of operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, in operation S701, a vehicle control method may include an operation of identify a first reference point within a line segment corresponding to a rear surface of an external vehicle among line segments forming a first virtual box based on obtaining the first virtual box corresponding to the external vehicle identified through a LiDAR.

According to an example, the vehicle control method may include an operation of generating a histogram based on a region, which is divided by the grids, on the basis of a coordinate of a second axis of the first reference point tracked on a plane formed by a first axis and the second axis among the first axis, the second axis, and a third axis. For example, the first axis may include an x-axis. For example, the second axis may include a y-axis. For example, the third axis may include a z-axis. However, the first axis, the second axis, and the third axis are not limited to the above examples.

According to an example, the vehicle control method may include an operation of generating the histogram based on the first reference point identified in regions divided by the grids, and partial regions obtained by dividing the regions at a designated interval. The regions divided by the grids may include regions for dividing lanes on each of which the host vehicle is capable of driving.

In operation S703, the vehicle control method according to an example may include an operation of removing points, which are placed in a region different from a region where a host vehicle is capable of driving, from among points obtained through a LiDAR relative to at least one of a second reference point of a second virtual box corresponding to a rear surface of a first stationary object among line segments forming the first stationary object, or a third reference point of a third virtual box corresponding to a rear surface of a second stationary object among line segments forming the second stationary object, or any combination thereof based on tracking a first reference point in regions divided by grids during frames of a designated section.

In operation S705, the vehicle control method according to an example may include an operation of identifying an error related to a location of the host vehicle based on a second location by comparing a first location of the host vehicle and the second location of the host vehicle, which is included in GPS information, based on receiving precise map information including the first location of the host vehicle through a communication circuit.

In operation S707, the vehicle control method according to an example may include an operation of comparing a first width of a road, on which the host vehicle is driving and which is included in the precise map information, with a second width based on a distance between the first stationary object and the second stationary object on the basis of identifying that the error is smaller than a reference error.

The vehicle control method according to an example may include an operation of identify at least one of a first coordinate of a second axis of the first reference point, a second coordinate of the second axis of the second reference point, or a third coordinate of the second axis of the third reference point, or any combination thereof, which is identified on a plane formed by the first axis and the second axis among the first axis, the second axis, and the third axis. The vehicle control method according to an example may include an operation of identifying that the first stationary object is further located to a left side than the host vehicle based on the first coordinate of the second axis exceeding the second coordinate of the second axis, identifying that the first stationary object is further located to a right side than the host vehicle based on the first coordinate of the second axis being smaller than the second coordinate of the second axis, identifying that the second stationary object is further located to a left side than the host vehicle based on the first coordinate of the second axis exceeding the third coordinate of the second axis, or identifying that the second stationary object is further located to a right side than the host vehicle based on the first coordinate of the second axis being smaller than the third coordinate of the second axis.

The vehicle control method according to an example may include an operation of identifying the first location and the second location in the grids for dividing a plane formed by the first axis and the second axis among the first axis, the second axis, and the third axis, identifying a first error of a direction of the first axis of the host vehicle based on a first coordinate of the first axis included in the first location and a second coordinate of the first axis included in the second location, identifying a second error of a direction of the second axis of the host vehicle based on a fourth coordinate of the second axis included in the first location and a fifth coordinate of the second axis included in the second location, and comparing the first width with the second width based on the first error being smaller than a first reference error, and the second error being smaller than a second reference error.

In operation S709, the vehicle control method according to an example may include an operation of identifying at least one of the first stationary object, or the second stationary object, or any combination thereof as a road edge, based on the difference between the first width and the second width being smaller than or equal to a first reference width.

According to an example, the vehicle control method may include an operation of not identifying at least one of the first stationary object, or the second stationary object, or any combination thereof as a road edge based on the difference between the first width and the second width being greater than the first reference width.

According to an example, the vehicle control method may include an operation of identifying a region, in which the host vehicle is capable of driving, from among regions divided by the grids, and not identifying at least one of the first stationary object, or the second stationary object, or any combination thereof as a road edge based on identifying a stationary object, which is different from at least one of the first stationary object, or the second stationary object, or the combination thereof, in a region adjacent to a region where at least one of the first stationary object, or the second stationary object, or any combination thereof is present.

According to an example, the vehicle control method may include an operation of identifying the first stationary object as a first road edge based on a fact that a length of the second virtual box is greater than or equal to a first reference length, virtual boxes, each of which is different from the second virtual box, are not present in a region where the second virtual box is identified, a distance between the second reference point and the host vehicle is smaller than or equal to a first reference distance, and the second virtual box includes the designated type of points by the second reference number or more, or identifying the second stationary object as a second road edge based on a length of the third virtual box is greater than or equal to the first reference length, virtual boxes, each of which is different from the third virtual box, are not present in a region where the third virtual box is identified, a distance between the third reference point and the host vehicle is smaller than or equal to the first reference distance, and the third virtual box includes the designated type of points by the second reference number or more.

According to an example, the vehicle control method may include an operation of identifying at least one of the first stationary object, or the second stationary object, or any combination thereof as a road edge based on at least one of a length of the second virtual box, or a length of the third virtual box, or any combination thereof being greater than or equal to a second reference length.

According to an example, the vehicle control method may include an operation of identifying a first point, which is closest to the host vehicle, from among points included in the second virtual box, identifying a second point, which is closest to the host vehicle, from among points included in the third virtual box, and identifying at least one of the first stationary object, or the second stationary object, or any combination thereof as a road edge, based on a fact that a difference between a distance between the first point and the second point and a road width included in the precise map information is smaller than or equal to a second reference width.

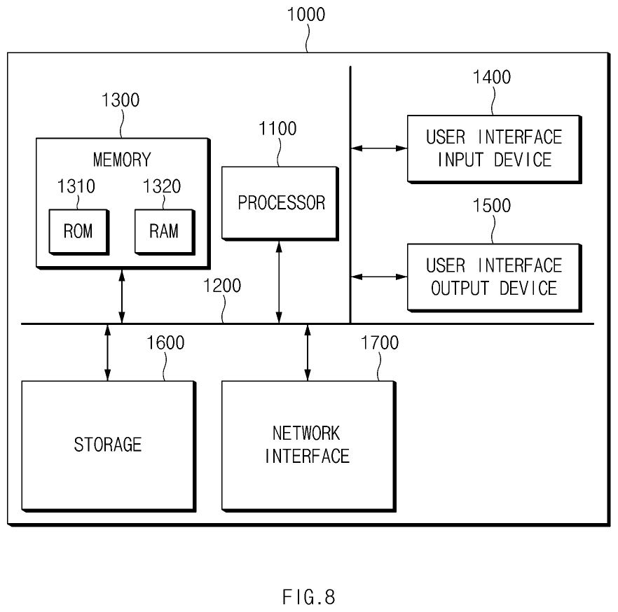

FIG. 8 shows an example of a computing system associated with a vehicle control apparatus, according to an example of the present disclosure.

Referring to FIG. 8, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, or a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively or additionally, the storage medium may be integrated with the processor 1100. The processor and storage medium may be implemented with an application specific integrated circuit (ASIC). The ASIC may be provided in a user terminal. Alternatively or additionally, the processor and storage medium may be implemented with separate components in the user terminal.

The present disclosure has been made to solve the above-mentioned problems occurring in the prior art while advantages achieved by the prior art are maintained intact.

An example of the present disclosure provides a vehicle control apparatus for identifying a road edge by using a histogram generated based on tracking a moving object, and a method thereof.

An example of the present disclosure provides a vehicle control apparatus for identifying a region, in which a host vehicle is capable of driving, by using width information included in map information and distance information between virtual boxes, and a method thereof.

An example of the present disclosure provides a vehicle control apparatus for reducing the occurrence of errors in a vehicle control system associated with the vehicle control apparatus by accurately identifying a road edge, and a method thereof.

The technical problems to be solved by the present disclosure are not limited to the aforementioned problems, and any other technical problems not mentioned herein will be clearly understood the following description by those skilled in the art to which the present disclosure pertains.

According to an example of the present disclosure, a vehicle control apparatus may include a light detection and ranging (LiDAR) and a processor. The processor may identify a first reference point within a line segment corresponding to a rear surface of an external vehicle among line segments forming a first virtual box based on obtaining the first virtual box corresponding to the external vehicle identified through the LiDAR, may remove points, which are placed in a region different from a region where a host vehicle is capable of driving, from among points obtained through the LiDAR relative to at least one of a second reference point located within a line segment corresponding to a rear surface of a first stationary object among line segments forming a second virtual box corresponding to the first stationary object, or a third reference point located within a line segment corresponding to a rear surface of a second stationary object among line segments forming a third virtual box corresponding to the second stationary object, or any combination thereof based on tracking the first reference point in regions divided by grids during frames of a designated section, may identify an error related to a location of the host vehicle based on a second location by comparing a first location of the host vehicle and the second location of the host vehicle, which is included in global positioning system (GPS) information, based on receiving precise map information including the first location of the host vehicle through the communication circuit, may compare a first width of a road, on which the host vehicle is driving and which is included in the precise map information, with a second width based on a distance between the first stationary object and the second stationary object based on identifying that the error is smaller than a reference error, and may identify at least one of the first stationary object, or the second stationary object, or any combination thereof as a road edge based on a difference between the first width and the second width being smaller than or equal to a first reference width.

In an example, the processor may not identify at least one of the first stationary object, or the second stationary object, or any combination thereof as a road edge based on the difference between the first width and the second width being greater than the first reference width.

In an example, the processor may generate a histogram based on a region, which is divided by the grids, based on a coordinate of a second axis of the first reference point tracked on a plane formed by a first axis and the second axis among the first axis, the second axis, and a third axis.

In an example, the processor may generate the histogram based on the first reference point identified in regions divided by the grids, and partial regions obtained by dividing the regions at a designated interval. The regions divided by the grids may include regions for dividing lanes on each of which the host vehicle is capable of driving.

In an example, the processor may identify at least one of a first coordinate of a second axis of the first reference point, a second coordinate of the second axis of the second reference point, or a third coordinate of the second axis of the third reference point, or any combination thereof, which is identified on a plane formed by a first axis and the second axis among the first axis, the second axis, and a third axis, and may identify that the first stationary object is further located to a left side than the host vehicle based on the first coordinate of the second axis exceeding the second coordinate of the second axis, may identify that the first stationary object is further located to a right side than the host vehicle based on the first coordinate of the second axis being smaller than the second coordinate of the second axis, may identify that the second stationary object is further located to a left side than the host vehicle based on the first coordinate of the second axis exceeding the third coordinate of the second axis, or may identify that the second stationary object is further located to a right side than the host vehicle based on the first coordinate of the second axis being smaller than the third coordinate of the second axis.

In an example, the processor may identify the first stationary object as a first road edge based on a fact that a length of the second virtual box is greater than or equal to a first reference length, virtual boxes, each of which is different from the second virtual box, are not present in a region where the second virtual box is identified, a distance between the second reference point and the host vehicle is smaller than or equal to a first reference distance, and the second virtual box includes a designated type of points by a second reference number or more, or may identify the second stationary object as a second road edge based on a length of the third virtual box is greater than or equal to the first reference length, virtual boxes, each of which is different from the third virtual box, are not present in a region where the third virtual box is identified, a distance between the third reference point and the host vehicle is smaller than or equal to the first reference distance, and the third virtual box includes a designated type of points by the second reference number or more.

In an example, the processor may identify the first location and the second location in the grids for dividing a plane formed by a first axis and a second axis among the first axis, the second axis, and a third axis, may identify a first error of a direction of the first axis of the host vehicle based on a first coordinate of the first axis included in the first location and a second coordinate of the first axis included in the second location, may identify a second error of a direction of the second axis of the host vehicle based on a fourth coordinate of the second axis included in the first location and a fifth coordinate of the second axis included in the second location, and may compare the first width with the second width based on the first error being smaller than a first reference error, and the second error being smaller than a second reference error.

In an example, the processor may identify a region, in which the host vehicle is capable of driving, from among regions divided by the grids, and may not identify at least one of the first stationary object, or the second stationary object, or any combination thereof as a road edge based on identifying a stationary object, which is different from at least one of the first stationary object, or the second stationary object, or any combination thereof, in a region adjacent to a region where at least one of the first stationary object, or the second stationary object, or any combination thereof are present.

In an example, the processor may identify at least one of the first stationary object, or the second stationary object, or any combination thereof as a road edge based on at least one of a length of the second virtual box, or a length of the third virtual box, or any combination thereof being greater than or equal to a second reference length.

In an example, the processor may identify a first point, which is closest to the host vehicle, from among points included in the second virtual box, may identify a second point, which is closest to the host vehicle, from among points included in the third virtual box, and may identify at least one of the first stationary object, or the second stationary object, or any combination thereof as a road edge, based on a fact that a difference between a distance between the first point and the second point and a road width included in the precise map information is smaller than or equal to a second reference width.

According to an example of the present disclosure, a vehicle control method may include identifying a first reference point within a line segment corresponding to a rear surface of an external vehicle among line segments forming a first virtual box based on obtaining the first virtual box corresponding to the external vehicle identified through a LiDAR, removing points, which are placed in a region different from a region where a host vehicle is capable of driving, from among points obtained through the LiDAR relative to at least one of a second reference point located within a line segment corresponding to a rear surface of a first stationary object among line segments forming a second virtual box corresponding to the first stationary object, or a third reference point located within a line segment corresponding to a rear surface of a second stationary object among line segments forming a third virtual box corresponding to the second stationary object, or any combination thereof based on tracking the first reference point in regions divided by grids during frames of a designated section, identifying an error related to a location of the host vehicle based on a second location by comparing a first location of the host vehicle and the second location of the host vehicle, which is included in GPS information, based on receiving precise map information including the first location of the host vehicle through a communication circuit, comparing a first width of a road, on which the host vehicle is driving and which is included in the precise map information, with a second width based on a distance between the first stationary object and the second stationary object based on identifying that the error is smaller than a reference error, and identifying at least one of the first stationary object, or the second stationary object, or any combination thereof as a road edge based on a difference between the first width and the second width being smaller than or equal to a first reference width.

According to an example, the vehicle control method may further include not identifying at least one of the first stationary object, or the second stationary object, or any combination thereof as a road edge based on the difference between the first width and the second width being greater than the first reference width.

According to an example, the vehicle control method may further include generating a histogram based on a region, which is divided by the grids, based on a coordinate of a second axis of the first reference point tracked on a plane formed by a first axis and the second axis among the first axis, the second axis, and a third axis.

According to an example, the vehicle control method may further include generating the histogram based on the first reference point identified in regions divided by the grids, and partial regions obtained by dividing the regions at a designated interval. The regions divided by the grids may include regions for dividing lanes on each of which the host vehicle is capable of driving.

According to an example, the vehicle control method may further include identifying at least one of a first coordinate of a second axis of the first reference point, a second coordinate of the second axis of the second reference point, or a third coordinate of the second axis of the third reference point, or any combination thereof, which is identified on a plane formed by a first axis and the second axis among the first axis, the second axis, and a third axis, identifying that the first stationary object is further located to a left side than the host vehicle based on the first coordinate of the second axis exceeding the second coordinate of the second axis, identifying that the first stationary object is further located to a right side than the host vehicle based on the first coordinate of the second axis being smaller than the second coordinate of the second axis, identifying that the second stationary object is further located to a left side than the host vehicle based on the first coordinate of the second axis exceeding the third coordinate of the second axis, or identifying that the second stationary object is further located to a right side than the host vehicle based on the first coordinate of the second axis being smaller than the third coordinate of the second axis.

According to an example, the vehicle control method may further include identifying the first stationary object as a first road edge based on a fact that a length of the second virtual box is greater than or equal to a first reference length, virtual boxes, each of which is different from the second virtual box, are not present in a region where the second virtual box is identified, a distance between the second reference point and the host vehicle is smaller than or equal to a first reference distance, and the second virtual box includes a designated type of points by a second reference number or more, or identifying the second stationary object as a second road edge based on a length of the third virtual box is greater than or equal to the first reference length, virtual boxes, each of which is different from the third virtual box, are not present in a region where the third virtual box is identified, a distance between the third reference point and the host vehicle is smaller than or equal to the first reference distance, and the third virtual box includes a designated type of points by the second reference number or more.

In an example, the vehicle control method may further include identifying the first location and the second location in the grids for dividing a plane formed by a first axis and a second axis among the first axis, the second axis, and a third axis, identifying a first error of a direction of the first axis of the host vehicle based on a first coordinate of the first axis included the first location and a second coordinate of the first axis included in the second location, identifying a second error of a direction of the second axis of the host vehicle based on a fourth coordinate of the second axis included in the first location and a fifth coordinate of the second axis included in the second location, and comparing the first width with the second width based on the first error being smaller than a first reference error, and the second error being smaller than a second reference error.

According to an example, the vehicle control method may further include identifying a region, in which the host vehicle is capable of driving, from among regions divided by the grids, and not identifying at least one of the first stationary object, or the second stationary object, or any combination thereof as a road edge based on identifying a stationary object, which is different from at least one of the first stationary object, or the second stationary object, or any combination thereof, in a region adjacent to a region where at least one of the first stationary object, or the second stationary object, or any combination thereof are present.

According to an example, the vehicle control method may further include identifying at least one of the first stationary object, or the second stationary object, or any combination thereof as a road edge based on at least one of a length of the second virtual box, or a length of the third virtual box, or any combination thereof being greater than or equal to a second reference length.

According to an example, the vehicle control method may further include identifying a first point, which is closest to the host vehicle, from among points included in the second virtual box, identifying a second point, which is closest to the host vehicle, from among points included in the third virtual box, and identifying at least one of the first stationary object, or the second stationary object, or any combination thereof as a road edge, based on a fact that a difference between a distance between the first point and the second point and a road width included in the precise map information is smaller than or equal to a second reference width.

The above description is merely an example of the present disclosure, and various technical idea of the modifications and modifications may be made by one skilled in the art without departing from the characteristic of the present disclosure.

Accordingly, t disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may identify a road edge by using a histogram generated based on tracking a moving object.

Moreover, the present technology may identify a region, in which a host vehicle is capable of driving, by using width information included in map information and distance information between virtual boxes.

Furthermore, the present technology may reduce the occurrence of errors in a vehicle control system associated with the vehicle control apparatus by accurately identifying a road edge.

Besides, a variety of effects directly or indirectly understood through the specification may be provided.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a sensor;
a communication circuit; and
a processor,
wherein the processor is configured to:
determine a first reference point within a line segment corresponding to a rear surface of an external vehicle, wherein the line segment is one of line segments forming a first virtual box corresponding to the external vehicle detected through the sensor;
remove, based on tracking the first reference point in regions divided by grids associated with frames of a designated section, points from a plurality of points obtained through the sensor relative to at least one of:
a second reference point located within a second line segment corresponding to a rear surface of a first stationary object, wherein the second line segment is one of line segments forming a second virtual box corresponding to the first stationary object, or
a third reference point located within a third line segment corresponding to a rear surface of a second stationary object, wherein the third line segment is one of line segments forming a third virtual box corresponding to the second stationary object wherein the points are placed in a region different from a region where a host vehicle is present;
determine an error related to a location of the host vehicle by comparing:
a first location, of the host vehicle, which is included in map information received through the communication circuit and
a second location, of the host vehicle, which is included in global positioning system (GPS) information;
based on determining that the error is smaller than a reference error, compare:
a first width of a road, on which the host vehicle is driving and which is included in the map information and
a second width based on a distance between the first stationary object and the second stationary object;
determine at least one of the first stationary object or the second stationary object as a road edge, based on a difference between the first width and the second width being smaller than or equal to a first reference width; and
output a signal indicating the road edge.

2. The apparatus of claim 1, wherein the processor is configured to:
determine that at least one of the first stationary object or the second stationary object is not a road edge, based on the difference between the first width and the second width being greater than the first reference width.

3. The apparatus of claim 1, wherein the processor is configured to:
generate a histogram based on a region and a coordinate of a second axis of the first reference point tracked on a plane formed by a first axis and the second axis, wherein:
the region is divided by the grids,
the first axis corresponds to a driving direction of the host vehicle, and
the second axis is perpendicular to the first axis.

4. The apparatus of claim 3, wherein the processor is configured to:
generate the histogram based on the first reference point detected in the regions divided by the grids and partial regions obtained by dividing the regions at a designated interval, and
wherein the regions divided by the grids include regions for dividing lanes on each of which the host vehicle is capable of driving.

5. The apparatus of claim 1, wherein the processor is configured to:
determine at least one of:
a first coordinate of a second axis of the first reference point,
a second coordinate of the second axis of the second reference point, or
a third coordinate of the second axis of the third reference point, wherein the at least one of the first coordinate, the second coordinate, or the third reference point is identified on a plane formed by a first axis and the second axis perpendicular to the first axis, wherein the first axis corresponds to a driving direction of the host vehicle; and
determine that the first stationary object is located to a left side of the host vehicle based on the first coordinate of the second axis exceeding the second coordinate of the second axis,
determine that the first stationary object is located to a right side of the host vehicle based on the first coordinate of the second axis being smaller than the second coordinate of the second axis,
determine that the second stationary object is located to a left side of the host vehicle based on the first coordinate of the second axis exceeding the third coordinate of the second axis, or
determine that the second stationary object is located to a right side of the host vehicle based on the first coordinate of the second axis being smaller than the third coordinate of the second axis.

6. The apparatus of claim 1, wherein the processor is configured to:
determine the first stationary object as a first road edge based on:
a length of the second virtual box being greater than or equal to a first reference length,
virtual boxes, each of which is different from the second virtual box, not being present in a region where the second virtual box is detected,
a distance between the second reference point and the host vehicle being smaller than or equal to a first reference distance, and
the second virtual box including a designated type of points by a second reference number or more; or
determine the second stationary object as a second road edge based on:
a length of the third virtual box being greater than or equal to the first reference length,
virtual boxes, each of which is different from the third virtual box, not being present in a region where the third virtual box is detected,
a distance between the third reference point and the host vehicle being smaller than or equal to the first reference distance, and
the third virtual box including a designated type of points by the second reference number or more.

7. The apparatus of claim 1, wherein the processor is configured to:
determine the first location and the second location in the grids for dividing a plane formed by a first axis and a second axis, wherein the first axis corresponds to a driving direction of the host vehicle and the second axis is perpendicular to the first axis;
determine a first error in a direction of the first axis based on:
a first coordinate of the first axis included in the first location and
a second coordinate of the first axis included in the second location;
determine a second error in a direction of the second axis of the host vehicle based on:
a fourth coordinate of the second axis included in the first location and
a fifth coordinate of the second axis included in the second location; and
compare, based on the first error being smaller than a first reference error and the second error being smaller than a second reference error, the first width and the second width.

8. The apparatus of claim 1, wherein the processor is configured to:
determine a region, in which the host vehicle is capable of driving, from among the regions divided by the grids; and
determine that at least one of the first stationary object or the second stationary object is not a road edge, based on determining a stationary object, which is different from at least one of the first stationary object or the second stationary object in a region adjacent to a region where at least one of the first stationary object or the second stationary object is present.

9. The apparatus of claim 1, wherein the processor is configured to:
determine at least one of the first stationary object or the second stationary object as a road edge based on at least one of a length of the second virtual box or a length of the third virtual box being greater than or equal to a second reference length.

10. The apparatus of claim 9, wherein the processor is configured to:
determine a first point, which is closest to the host vehicle, from among points included in the second virtual box;
determine a second point, which is closest to the host vehicle, from among points included in the third virtual box; and
determine at least one of the first stationary object or the second stationary object as a road edge, based on:
a difference between a distance between the first point and the second point and
a road width included in the map information being smaller than or equal to a second reference width.

11. A method comprising:
determining a first reference point within a line segment corresponding to a rear surface of an external vehicle, wherein the line segment is one of line segments forming a first virtual box corresponding to the external vehicle detected through a sensor;
removing, based on tracking the first reference point in regions divided by grids associated with frames of a designated section, points from a plurality of points obtained through the sensor relative to at least one of:
a second reference point located within a second line segment corresponding to a rear surface of a first stationary object, wherein the second line segment is one of the line segments forming a second virtual box corresponding to the first stationary object, or
a third reference point located within a third line segment corresponding to a rear surface of a second stationary object, wherein the third line segment is one of the line segments forming a third virtual box corresponding to the second stationary object;
determining an error related to a location of a host vehicle by comparing:
a first location, of the host vehicle, which is included in map information received through a communication circuit and
a second location of the host vehicle, which is included in GPS information;
based on determining that the error is smaller than a reference error, comparing:
a first width of a road, on which the host vehicle is driving and which is included in the map information and
a second width based on a distance between the first stationary object and the second stationary object;
determining at least one of the first stationary object or the second stationary object as a road edge, based on a difference between the first width and the second width being smaller than or equal to a first reference width; and
outputting a signal indicating the road edge.

12. The method of claim 11, further comprising:
determining that at least one of the first stationary object or the second stationary object is not a road edge, based on the difference between the first width and the second width being greater than the first reference width.

13. The method of claim 11, further comprising:
generating a histogram based on a region and a coordinate of a second axis of the first reference point tracked on a plane formed by a first axis and the second axis, wherein:
the region is divided by the grids,
the first axis corresponds to a driving direction of the host vehicle, and
the second axis is perpendicular to the first axis.

14. The method of claim 13, further comprising:
generating the histogram based on the first reference point detected in the regions divided by the grids and partial regions obtained by dividing the regions at a designated interval, and
wherein the regions divided by the grids include regions for dividing lanes on each of which the host vehicle is capable of driving.

15. The method of claim 11, further comprising:
determining at least one of:
a first coordinate of a second axis of the first reference point,
a second coordinate of the second axis of the second reference point, or
a third coordinate of the second axis of the third reference point, wherein the at least one of the first coordinate, the second coordinate, or the third reference point is identified on a plane formed by a first axis and the second axis perpendicular to the first axis, wherein the first axis corresponds to a driving direction of the host vehicle; and
determining that the first stationary object is located to a left side of the host vehicle based on the first coordinate of the second axis exceeding the second coordinate of the second axis;
determining that the first stationary object is located to a right side of the host vehicle based on the first coordinate of the second axis being smaller than the second coordinate of the second axis;
determining that the second stationary object is located to a left side of the host vehicle based on the first coordinate of the second axis exceeding the third coordinate of the second axis; or
determining that the second stationary object is located to a right side of the host vehicle based on the first coordinate of the second axis being smaller than the third coordinate of the second axis.

16. The method of claim 11, further comprising:
determining the first stationary object as a first road edge based on:
a length of the second virtual box being greater than or equal to a first reference length,
virtual boxes, each of which is different from the second virtual box, not being present in a region where the second virtual box is detected,
a distance between the second reference point and the host vehicle being smaller than or equal to a first reference distance, and
the second virtual box including a designated type of points by a second reference number or more; or
determining the second stationary object as a second road edge based on:
a length of the third virtual box being greater than or equal to the first reference length,
virtual boxes, each of which is different from the third virtual box, not being present in a region where the third virtual box is detected,
a distance between the third reference point and the host vehicle being smaller than or equal to the first reference distance, and
the third virtual box including a designated type of points by the second reference number or more.

17. The method of claim 11, further comprising:
determining the first location and the second location in the grids for dividing a plane formed by a first axis and a second axis, wherein the first axis corresponds to a driving direction of the host vehicle and the second axis is perpendicular to the first axis;
determining a first error in a direction of the first axis based on:
a first coordinate of the first axis included in the first location and
a second coordinate of the first axis included in the second location;
determining a second error in a direction of the second axis of the host vehicle based on:
a fourth coordinate of the second axis included in the first location and
a fifth coordinate of the second axis included in the second location; and
comparing, based on the first error being smaller than a first reference error and the second error being smaller than a second reference error, the first width and the second width.

18. The method of claim 11, further comprising:
determining a region, in which the host vehicle is capable of driving, from among the regions divided by the grids; and
determining that at least one of the first stationary object or the second stationary object is not a road edge based on determining a stationary object, which is different from at least one of the first stationary object or the second stationary object in a region adjacent to a region where at least one of the first stationary object is present.

19. The method of claim 11, further comprising:
determining at least one of the first stationary object or the second stationary object as a road edge based on at least one of a length of the second virtual box or a length of the third virtual box being greater than or equal to a second reference length.

20. The method of claim 19, further comprising:
determining a first point, which is closest to the host vehicle, from among points included in the second virtual box;
determining a second point, which is closest to the host vehicle, from among points included in the third virtual box; and
determining at least one of the first stationary object or the second stationary object as a road edge, based on:
a difference between a distance between the first point and the second point and
a road width included in the map information being smaller than or equal to a second reference width.
